(19) United States
(12) Patent Application Publication
(10) Pub. No.: US 2021/0388474 A1
(43) Pub. Date: Dec. 16, 2021

(54) HIGH MAGNETIC FLUX DENSITY SOFT MAGNETIC FE-BASED AMORPHOUS ALLOY

(71) Applicants: BMG Co., Ltd., Sendai (JP); GUANGZHOU LOCONTECH CO., LTD, GUANGZHOU CITY (CN)

(72) Inventors: Akihisa INOUE, Togane-shi Chiba-ken (JP); Fanli KONG, Togane-shi Chiba-ken (JP); Shengli ZHU, Nankai District (CN); Fang WANG, Nankai District (CN)

(21) Appl. No.: 17/129,140

(22) Filed: Dec. 21, 2020

(30) Foreign Application Priority Data
Jun. 10, 2020 (JP) 2020-101043

(51) Int. Cl. C22C 38/10; C22C 38/02; C22C 38/00

(52) U.S. Cl. CPC C22C 38/10; C22C 2202/02; C22C 38/002; C22C 38/02

(57) ABSTRACT

According to the present invention, provided is a high magnetic flux density soft magnetic Fe-based amorphous alloy represented by a composition formula of the following formula (I):

(Fe₁₋ₓCoₓ)ₐB_{b}Si_{c}C_{d} (I)

wherein, 0.02≤X≤0.1,
a, b, c, and d each represent atomic %, 82.5≤a≤84, 14≤b≤16, 1≤c≤2, 0.5≤d≤1, and a+b+c+d=100.

### CROSS-REFERENCE TO RELATED APPLICATIONS

The present application claims priority under 35 U.S.C. § 119 to Japanese Patent Application No. 2020-101043, filed on Jun. 10, 2020. The above application is hereby expressly incorporated by reference, in its entirety, into the present application.

### BACKGROUND OF THE INVENTION

The present invention relates to a high saturation magnetic flux density soft magnetic Fe-based amorphous alloy. More specifically, the present invention relates to a high magnetic flux density soft magnetic Fe-based amorphous alloy having a low coercive force, a high initial magnetic permeability, and a high effective magnetic permeability, and also having an extremely high saturation magnetic flux density of 1.8 T class. The amorphous alloy of the present invention can be suitably applied to motor iron cores, high-efficiency transformers, high-efficiency inductors of personal computers and the like, high-sensitivity sensors, magnetic shields of various electromagnetic materials, and the like.

Conventionally, in various alloy systems, amorphous alloys having an amorphous structure in which atoms are randomly arranged have been found, and various products that take advantages of high strength due to the atomic arrangement, good soft magnetic properties, chemical stability, and the like have been developed.

Among these amorphous alloys, in particular, Fe-based amorphous alloys containing Fe as a main component are recognized to have advantages such as higher saturation magnetic flux density than those of other metal-based amorphous alloys. However, recently, even higher saturation magnetic flux density is required, and research and development are being actively conducted (JP 61-64844 A, JP 2014-167138 A, JP 2015-127436 A, and JP 2018-123424 A) .

### SUMMARY OF THE INVENTION

The present invention has been made in view of the above conventional circumstances, and an object thereof is to provide a high magnetic flux density soft magnetic Fe-based amorphous alloy having a low coercive force, a high initial magnetic permeability, and a high effective magnetic permeability, and also having an extremely high saturation magnetic flux density of 1.8 T class.

In order to achieve the above object, the present invention provides a high magnetic flux density soft magnetic Fe-based amorphous alloy represented by a composition formula of the following formula (I):

(Fe₁₋ₓCoₓ)ₐB_{b}Si_{c}C_{d} (I)

wherein, 0.02≤X≤0.1,
a, b, c, and d each represent atomic %, 82.5≤a≤84, 14≤b≤16, 1≤c≤2, 0.5≤d≤1, and a+b+c+d=100.

Here, it is preferable that B/Si is 4 to 15 (atomic % ratio) in the above formula (I).

In addition, it is preferable that the high magnetic flux density soft magnetic Fe-based amorphous alloy has a saturation magnetic flux density (Bs) of 1.79 T or more.

The present invention provides a high magnetic flux density soft magnetic Fe-based amorphous alloy having a low coercive force, a high initial magnetic permeability, a high effective magnetic permeability, and an extremely high saturation magnetic flux density of 1.8 T class.

### DETAILED DESCRIPTION OF THE INVENTION

Hereinafter, the present invention will be described in detail.

The high magnetic flux density soft magnetic Fe-based amorphous alloy according to the present invention is represented by a composition formula of the following formula (I).

(Fe₁₋ₓCoₓ)ₐB_{b}Si_{c}C_{d} (I)

wherein, 0.02≤X≤0.1,
a, b, c, and d each represent atomic %, 82.5≤a≤84, 14≤b≤16, 1≤c≤2, 0.5≤d≤1, and a+b+c+d=100.

In the present invention, by setting values of a, b, c, d, and X within the above ranges, respectively, in the above formula (I), the alloy has a low coercive force, a high initial magnetic permeability, and a high effective magnetic permeability, and can also have an effect of having an extremely high saturation magnetic flux density of 1.8 T class. When any of the values deviates from the above range, the alloy cannot have the above-mentioned effect of the present invention.

The present invention also has a multi-metalloid composition obtained by combining metalloids B and Si in the above formula (I). The multi-metalloid element effect improves thermal stability of amorphous structure and also increases resistance to crystallization. In the present invention, a blending ratio of these metalloids B/Si is preferably 4 to 15 (atomic % ratio), and more preferably 7 to 14 (atomic %). By blending B/Si in the above ratio, a particularly excellent effect is exhibited in that an amorphous phase can be generated even in an alloy containing (Fe +Co) at a high concentration, and the like.

Conventionally, among Fe-based amorphous alloys, Fe—P—B—Si-based amorphous alloys and the like are known to have various good soft magnetic and mechanical properties. However, Fe-based amorphous alloys containing P elements have problems such as difficulty in adjusting P element concentration and high cost of Fe—P master alloy ingot, and it has been desired to develop an Fe-based amorphous alloy containing no P element, also in terms of improvement of stability of amorphous phase, reduction of production cost, and the like. The present invention meets such a demand. That is, instead of the amorphous alloy containing P such as the above-mentioned Fe—P—B—Si based amorphous alloy, a (Fe, Co)—B—Si—C based amorphous alloy obtained by using an elemental composition of Fe—B—Si based amorphous alloy, adding C thereto and using Fe and Co in combination was used, and the blending ratio of these blended elements was optimized to a specific range, especially, the concentration of Co element was lowered, whereby it was possible to achieve a high magnetic flux density, and also reduce the production cost. Such an amorphous alloy having the constitution of the present invention has a low Curie temperature (Tc), and therefore, there are advantages that in-magnetic-field heat treatment temperature can be lowered even in the heat treatment, the production process is also facilitated, and the like. Further, by blending C, the above-mentioned multi-metalloid element effect can be further enhanced.

The amorphous alloy of the present invention could exhibit a high saturation magnetic flux density characteristic of approximately 1.8 T or more, which is not usually obtained in a Fe-based amorphous alloy containing no Co, especially by optimizing the types and amounts of Co and metalloid elements. Further, when the alloy contains C, the melting point is lowered, and the glass forming ability is increased.

The high magnetic flux density soft magnetic Fe-based amorphous alloy according to the present invention of the above constitution can be prepared by a conventionally used method.

For example, a molten state of an alloy (alloy molten metal) of the composition represented by the above formula (I) is cooled and solidified by a single copper alloy roll quenching method to produce an amorphous alloy thin strip of a thin strip (ribbon shape) filament. Alternatively, the amorphous alloy film is formed by a vapor phase quenching method such as a sputtering method or a vapor method. When the single roll method is adopted, the alloy molten metal may be quenched in an inert gas atmosphere, a vacuum atmosphere, or an air atmosphere. In the case of the roll quenching method, the thickness of the thin plate material is preferably about 0.2 mm, and the roll peripheral speed is preferably about 30 to 40 m/s, but they are not particularly limited.

Subsequently, the above-mentioned thin strip is annealed. For annealing, for example, in-magnetic-field heat treatment in a magnetic field of 1 T or less is performed. In the present invention, when annealing is performed by in-magnetic-field heat treatment, that is, in-magnetic-field annealing, annealing temperature can be lowered. The annealing temperature in the in-magnetic-field heat treatment is preferably about (Tx1-10) K to (Tx1-40) K, and more preferably about (Tx1-20) K to (Tx1-30) K. Here, Tx1 is a first crystallization start temperature when a differential scanning calorific value is measured at a temperature rising rate of 0.67 K/s. The annealing time is about 4 to 45 minutes, and preferably about 10 to 30 minutes. The annealing atmosphere is not particularly limited, and examples thereof include a vacuum atmosphere, an argon atmosphere, a nitrogen atmosphere, and the like.

The present invention has a Curie temperature (Tc) in a lower temperature region than the crystallization start temperature (Tx1). In the heat treatment of the present invention, the in-magnetic-field annealing temperature can be lowered as described above, and when the Curie temperature (Tc) is low, there are advantages that the in-magnetic-field heat treatment temperature can be further suppressed low, the production cost is reduced, the production process is also facilitated, and the like. The in-magnetic-field annealing temperature is preferably in a temperature region between the Curie temperature (Tc) and the crystallization start temperature (Tx1) in terms of production efficiency and the like, but is not limited thereto.

The soft magnetic Fe-based amorphous alloy of the present invention thus obtained obtains an extremely high saturation magnetic flux density effect of having a saturation magnetic flux density (Bs) of about 1.8 T or more. In addition, the coercive force (Hc) can be suppressed to a low value of about 6 A/m or less, and the effective magnetic permeability (μe (1 kHz)) is 6,500 or more and the initial magnetic permeability (μi) is 18,000 or more, and thus the soft magnetic Fe-based amorphous alloy of the present invention can have these excellent effects.

Incidentally, heat treatment of the sample applied to obtain the amorphous alloy of the present invention is not particularly limited, and examples thereof include a method of performing conventional vacuum sealing, putting it in a heat treatment furnace, rapidly raising the temperature and quenching the sample.

However, in the case of a material showing high magnetic flux density soft magnetism like the amorphous alloy of the present invention, it is preferable to wrap the sample in aluminum or copper foil, put it into ash powder, carbon powder, fine sand, or fine iron oxide powder heated to a predetermined temperature in advance, and perform heat treatment, as compared with the conventional heat treatment method described above. By performing such a heat treatment, it becomes possible to perform heating to a predetermined temperature at a much more rapid heating rate and to finish the heating quickly.

As a result, in the high magnetic flux density soft magnetic Fe-based amorphous alloy of the present invention, precise temperature control enables short-time heat treatment at a temperature near the crystallization temperature, and thus superior soft magnetism (low coercive force, high magnetic permeability) can be obtained.

### EXAMPLES

Next, the present invention will be described in more detail with reference to examples, but the present invention is not limited thereto.

### Examples 1 to 11, Comparative Examples 1 to 7

Using alloys of compositions shown in Table 1 below, thin strips of amorphous phase with a thickness of 0.02 mm were prepared by a single roll liquid quenching method. Subsequently, the thin strips were annealed by in-magnetic-field heat treatment in a nitrogen gas atmosphere. The in-magnetic-field heat treatment was performed in a magnetic field of 0.2 T. Annealing temperature in the in-magnetic-field heat treatment was Tx1-(10 to 30) K, and annealing time was 5 to 30 minutes. Using these samples (alloys), the following items were measured and evaluated.

### [Confirmation of First Crystallization Temperature (Tx1) and Curie Temperature (Tc) of Alloy]

Tx1 and Tc were measured at a temperature rising rate of 20 to 40 K/min using a differential scanning calorimeter (DSC) and confirmed by the temperature of endothermic reaction. In Table 1, the evaluation “-” indicates that clear Tc could not be detected in the measurement by the differential scanning calorimeter (DSC).

### [Measurement of Bs (Saturation Magnetic Flux Density)]

Bs was measured in a 2 T μ magnetic field using a vibrating sample magnetometer (VSM).

### [Measurement of Hc (Coercive Force)]

Hc was measured at a magnetic field of 200 A/m using a magnetic field-magnetic (B-H) loop analyzer.

### [μe (Effective Magnetic Permeability)]

μe was measured in a wide range from 0.1 kHz to 10 MHz in an AC magnetic field of 5 mA/m using an impedance analyzer. Table 1 shows measurement results at 1 kHz.

### [μi (Initial Magnetic Permeability)]

μi was evaluated from a rising curve of magnetism due to a magnetic field load in a B-H loop analyzer.

The results are shown in Table 1.

TABLE 1

| | | Bs | Hc | | μe | Tx1 | Tc |
|---|---|---|---|---|---|---|---|
| | Alloy (atomic %) | (T) | (A/m) | μi | (1 kHz) | (K) | (K) |
| Example 1 | (Fer_{0.9} Co_{0.1})₈₄ B₁₄ Si₁ C₁ | 1.87 | 4.3 | 1.82 × 10⁴ | 0.68 × 10⁴ | 702 | 699 |
| Example 2 | (Fe_{0.9} Co_{0.1})₈₃ B₁₅ Si_{1.5} C_{0.5} | 1.82 | 4.6 | 1.92 × 10⁴ | 0.71 × 10⁴ | 707 | 696 |
| Example 3 | (Fe_{0.9} Co_{0.1})₈₂ B₁₆ Si_{1.5} C_{0.5} | 1.79 | 4.0 | 1.94 × 10⁴ | 0.74 × 10⁴ | 714 | 687 |
| Example 4 | (Fe_{0.9} Co_{0.1})_{83.5} B₁₄ Si₂ C_{0.5} | 1.83 | 4.5 | 1.88 × 10⁴ | 0.70 × 10⁴ | 701 | — |
| Example 5 | (Fe_{0.9} Co_{0.1})_{83.5} B₁₄ Si_{1.5} C₁ | 1.82 | 4.8 | 1.85 × 10⁴ | 0.68 × 10⁴ | 698 | — |
| Example 6 | (Fe_{0.9} Co_{0.1})_{82.5} B₁₅ Si₂ C_{0.5} | 1.80 | 4.1 | 1.91 × 10⁴ | 0.73 × 10⁴ | 708 | — |
| Example 7 | (Fe_{0.9} Co_{0.1})_{82.5} B₁₅ Si_{1.5} C₁ | 1.80 | 3.7 | 1.90 × 10⁴ | 0.71 × 10⁴ | 704 | — |
| Example 8 | (Fe_{0.95} Co_{0.05})₈₄ B₁₄ Si₁ C₁ | 1.82 | 5.8 | 1.80 × 10⁴ | 0.65 × 10⁴ | 711 | 674 |
| Example 9 | (Fe_{0.95} Co_{0.05})_{83.5} B_{14.5} Si_{1.5} C_{0.5} | 1.80 | 5.5 | 1.88 × 10⁴ | 0.68 × 10⁴ | 718 | 670 |
| Example 10 | (Fe_{0.95} Co_{0.05})_{83.5} B₁₄ Si_{1.5} C₁ | 1.81 | 6.1 | 1.87 × 10⁴ | 0.67 × 10⁴ | 709 | 668 |
| Example 11 | (Fe_{0.95} Co_{0.05})₈₃ B_{14.5} Si₂ C_{0.5} | 1.79 | 5.7 | 1.91 × 10⁴ | 0.64 × 10⁴ | 715 | — |
| Comparative | (Fe_{0.9} Co_{0.1})₈₁ B₁₇ Si₁ C₁ | 1.77 | 6.3 | 1.83 × 10⁴ | 0.98 × 10⁴ | 726 | 663 |
| Example 1 | | | | | | | |
| Comparative | (Fe_{0.95} Co_{0.05})₈₁ B₁₇ Si₁ C₁ | 1.70 | 7.1 | 1.65 × 10⁴ | 1.10 × 10⁴ | 727 | 650 |
| Example 2 | | | | | | | |
| Comparative | (Fe_{0.9} Co_{0.1})₈₀ B₁₆ Si₃ C₁ | 1.64 | 5.4 | 1.80 × 10⁴ | 1.23 × 10⁴ | 743 | 638 |
| Example 3 | | | | | | | |
| Comparative | (Fe_{0.95} Co_{0.05})_{79.5} B₁₇ Si₂ C_{1.5} | 1.58 | 5.5 | 1.68 × 10⁴ | 1.40 × 10⁴ | 758 | 624 |
| Example 4 | | | | | | | |
| Comparative | (Fe_{0.9} Co_{0.1})₈₁ B₁₇ Si₂ | 1.76 | 6.8 | 1.82 × 10⁴ | 0.93 × 10⁴ | 730 | 672 |
| Example 5 | | | | | | | |
| Comparative | (Fe_{0.95} Co_{0.05})₈₀ B₁₆ Si₄ | 1.63 | 5.9 | 1.78 × 10⁴ | 1.27 × 10⁴ | 747 | 643 |
| Example 6 | | | | | | | |
| Comparative | (Fe_{0.9} Co_{0.1})₈₂ B₁₆ Si₂ | 1.79 | 6.4 | 1.73 × 10⁴ | 0.92 × 10⁴ | 718 | 656 |
| Example 7 | | | | | | | |

As shown in Table 1, the samples shown in Examples 1 to 11 all had a saturation magnetic flux density (Bs) of about 1.8 T or more and a coercive force (Hc) of almost 6 A/m or less. In addition, it was confirmed that they had an effective magnetic permeability (μe) at 1 kHz of about 6,500 or more, and had extremely good soft magnetic properties. Moreover, they had an initial magnetic permeability (μi) of 18,000 or more. On the other hand, Comparative Examples 1 to 7 of compositions deviating from the scope of the present invention all had lower saturation magnetic flux density (Bs) and initial magnetic permeability (μi), and little higher coercive force (Hc), than those of Examples 1 to 11, and thus it was not possible to have all the effects of the present invention.

By X-ray diffraction method, it was confirmed that the compositions of Examples 1 to 11 and Comparative Examples 1 to 7 were all composed of only an amorphous phase.

The high magnetic flux density soft magnetic Fe-based amorphous alloy of the present invention has a low coercive force, a high initial magnetic permeability, and a high effective magnetic permeability, and also has an extremely high saturation magnetic flux density of 1.8 T class. Therefore, it can be suitably applied as an excellent soft magnetic material to a motor iron core, a high-efficiency transformer, a high-efficiency inductor of a personal computer or the like, a high-sensitivity sensor, a magnetic shield of various electromagnetic materials, or the like.

What is claimed is:

1. A high magnetic flux density soft magnetic Fe-based amorphous alloy represented by a composition formula of the following formula (I):
(Fe₁₋ₓCoₓ)ₐB_{b}Si_{c}C_{d} (I)
wherein, 0.02≤X≤0.1,
a, b, c, and d each represent atomic %, 82.5≤a≤84, 14≤b≤16, 1≤c≤2, 0.5≤d≤1, and a+b+c+d=100.

2. The high magnetic flux density soft magnetic Fe-based amorphous alloy according to claim 1, wherein B/Si is 4 to 15 (atomic % ratio) in the formula (I).

3. The high magnetic flux density soft magnetic Fe-based amorphous alloy according to claim 1, which has a saturation magnetic flux density (Bs) of 1.79 T or more.

4. The high magnetic flux density soft magnetic Fe-based amorphous alloy according to claim 2, which has a saturation magnetic flux density (Bs) of 1.79 T or more.
